(19) United States
(12) Patent Application Publication
(10) Pub. No.: US 2015/0119765 A1
(43) Pub. Date: Apr. 30, 2015

(54) Multi-Mode Massage Device Using Biofeedback

(71) Applicant: Jonathan Daniel Driscoll, San Diego, CA (US)

(72) Inventor: Jonathan Daniel Driscoll, San Diego, CA (US)

(21) Appl. No.: 14/065,377

(22) Filed: Oct. 28, 2013

(51) Int. Cl. A61H 23/02

(52) U.S. Cl. CPC A61H 23/02; A61H 2230/00
USPC 601/18; 601/46

(57) ABSTRACT

The present disclosure is directed to methods and systems for multi-mode personal massaging including a sensor unit configured to detect one or more biofeedback signals from a user of a personal massaging device or a partner. The system can further include a controller configured to analyze the one or more biofeedback signals, and determine one or more corresponding and modifiable outputs stored in a memory, based on the one or more biofeedback signals. The system can further include a massaging unit configured to output the one or more outputs determined by the controller, based on the one or more biofeedback signals.

### FIELD

The present disclosure relates to a massaging apparatus configured to receive biofeedback used to output predefined, reprogrammable stimuli algorithms.

### BACKGROUND

The therapeutic effect of vibratory or other stimulation on the human body has been well documented. Typically, personal massagers, such as handheld massagers, vibrating adult toys, and massage chairs, are designed to be completely autonomous, or to incorporate data from integrated sensors, such as pressure sensors or accelerometers. Moreover, conventional personal massagers are capable of storing pre-programmed routines selected by a user and downloadable via a USB connection, for example.

The prior art fails to disclose means to control such devices through sensors connected to a user, or another party, which allow for direct and/or automated control of the device using biofeedback of the user or the other party in real time.

### SUMMARY

The presently disclosed embodiments are directed to solving one or more of the problems presented in the prior art, as well as providing additional features that will become readily apparent by reference to the following description when taken in conjunction with the accompanying drawings.

Methods and devices described herein are directed to a multi-mode personal massaging system including a sensor unit or multiple sensor units configured to detect one or more biofeedback signals from one or more bodies. The system can further include a controller configured to analyze the one or more biopotential signals, and determine one or more corresponding predefined outputs stored in a memory, based on the one or more biopotential signals. The system can further include a massaging unit configured to output the one or more outputs determined by the controller, based on the one or more biopotential signals.

Another embodiment is directed to method for personal massaging. The method can include detecting one or more biopotential signals from one or more bodies; analyzing the one or more biofeedback signals, and determining one or more corresponding outputs, based on the one or more biopotential signals; and outputting the one or more determined predefined outputs, based on the one or more biopotential signals.

According to various embodiments, the biopotential signals can include electrocardiogram (EKG/ECG) signals, electromyography (EMG) signals, electroencephalography (EEG) signals, and signals derived from this, such as event related potential signals (ERP). The biofeedback signal can include motion of the device itself, which could be interpreted by an algorithm as specific gestures linked to a certain output (for instance, rotation of the device could be used to increase the vibration intensity), or in other manners, just as outputs that detect and lock-in output patterns to the user motions.

According to various embodiments, a user of a massaging device can experience varying, and modifiable, stimulation dependent upon biofeedback signals obtained from the user or a partner.

Further features and advantages of the present disclosure, as well as the structure and operation of various embodiments of the present disclosure, are described in further detail below.

### BRIEF DESCRIPTION OF THE DRAWINGS

The present disclosure, in accordance with one or more various embodiments, is described in details with reference to the following figures. The drawings are provided for purposes of illustration only and merely depict one exemplary embodiment of the disclosure. These drawings are provided to facilitate the reader's understanding of the disclosure and should not be considered limiting the breadth, scope, or applicability of the disclosure. It should be noted that for clarity and ease of illustration these drawings are not necessarily made to scale.

FIG. 1 is an exemplary personal massaging device, according to an embodiment of the present disclosure

FIG. 2 is a user with exemplary sensor units communicatively coupled to a personal massaging device, according to an embodiment of the present disclosure.

FIG. 3 is an exemplary sensor unit formed into a ring, according to an embodiment of the present disclosure.

FIG. 4 is an exemplary sensor unit formed into earrings, according to an embodiment of the present disclosure.

FIG. 5 is an exemplary sensor unit formed into spectacles, according to an embodiment of the present disclosure.

FIG. 6 is an exemplary multi-mode personal massaging system where biofeedback is obtained from a remote partner, according to an embodiment of the present disclosure.

### DETAILED DESCRIPTION OF EXEMPLARY EMBODIMENTS

The following description is presented to enable a person of ordinary skill in the art to make and use the invention. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the disclosure. Thus, the present disclosure is not intended to be limited to the examples described herein and shown, but is to be accorded the scope consistent with the claims.

The word “exemplary” is used herein to mean “serving as an example or illustration.” Any aspect or design described herein as “exemplary” is not necessarily to be construed as preferred or advantageous over other aspects or designs.

Moreover, it should be understood that the specific order or hierarchy of functional steps in the processes disclosed herein is an example of exemplary approaches. Based upon design preferences, it is understood that the specific order or hierarchy of steps in the processes may be rearranged while remaining within the scope of the present disclosure.

Embodiments described herein include a multi-mode personal massaging system in which a user of a massaging device can experience various pre-defined output stimuli dependent upon biofeedback (also referred to as “biopotential,” when appropriate) signals obtained by one or more sensors communicatively coupled to the user or another party. The biofeedback signals can be used to determine one or more outputs stored in a memory, such that the massaging device is configured to produce any corresponding output varying with the sensed biofeedback signals automatically in real time.

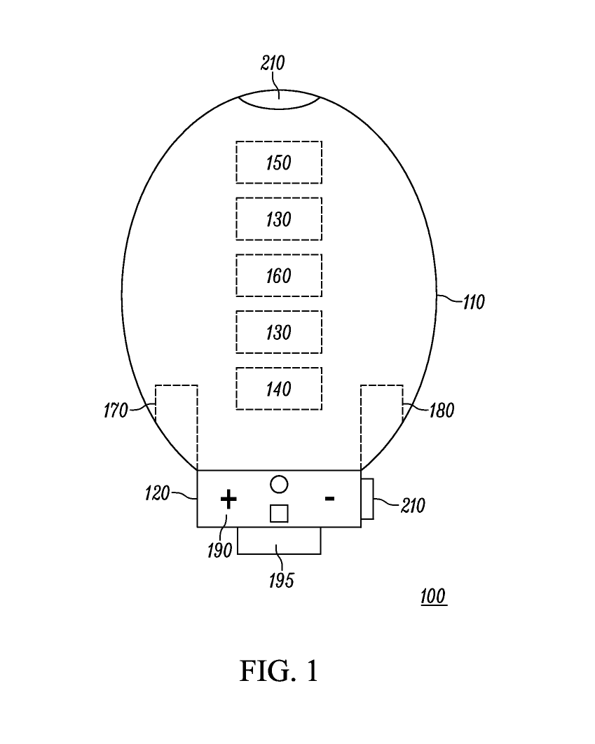

FIG. 1 illustrates an exemplary personal massaging device, according to an embodiment of the present disclosure. As shown in FIG. 1, the personal massaging device 100 (also called “personal massager”) includes a main body 110 that can house electronics and power source(s) 160 required to operate the device. Main body 110 can include one or more vibrator units 130, such as vibration motors, configured to cause the device 100 to vibrate, along with one or more accelerometers 140 (which could be any combination of accelerometer, gyroscope, and/or compass for sensing positioning and movement of the device 100) to detect angular positioning of the device 100. Main body 110 can further include a heating, unit 150 configured to heat the personal massaging device 100.

Personal massaging device 100 can include a handle 120 for the user to hold. Handle 120 can house one or more buttons 190, or other similar control elements, which allow the user to adjust various characteristics of the output of the personal massaging device 100, such as vibration intensity, temperature, or which on-board algorithm is in control of the input-output relationship, etc. The locations of the various components, the handle 120 and main body 110 are depicted in FIG. 1 as merely one example, and various configurations, as well as combinations of hardware, may be employed.

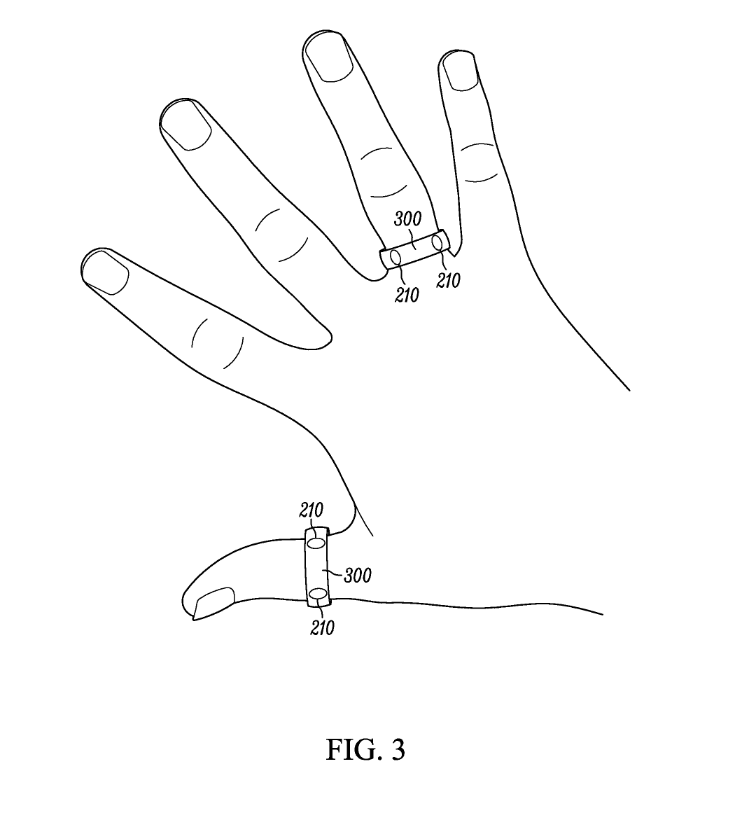

Main body 110 can further include a memory storage unit 170 configured to store predefined modes, or outputs, which can cause the vibrator unit(s) 130, lighting unit(s), heating unit(s) 150 and/or audio unit(s) to activate dependent upon various inputs provided by sensor units 210 (see FIG. 3). As described herein, according to an embodiment, biofeedback signal obtained by sensor units can be used to determine which of the one or more various modes, or outputs, the personal massaging device 100 can produce.

Main body 110 can also have a transceiver unit 195 configured to receive wireless signals transmitted by sensor units via Bluetooth, cellular connectivity. WiFi connectivity or any other similar wireless communication technique. Of course, one of ordinary skill in the art would realize that any conventional hard-wired connectivity can similarly be utilized, without departing from the scope of the present disclosure.

A control unit 180 may be employed within main body 100. The control unit may be a programmable processor configured to control the operation of the personal massaging device 100 and its components. For example, the control unit 180 may be a microcontroller (“MCU”), a general purpose hardware processor, a digital signal processor (“DSP”), an application specific integrated circuit (“ASIC”), field programmable gate array (“FPGA”) or other programmable logic device, discrete gate or transistor logic, discrete hardware components, or any combination thereof designed to perform the functions described herein. A general-purpose processor can be a microprocessor, but in the alternative, the processor can be any processor, controller, or microcontroller. A processor can also be implemented as a combination of computing devices, for example, a combination of a DSP and a microprocessor, a plurality of microprocessors, one or more microprocessors in conjunction with a DSP core, or any other such configuration.

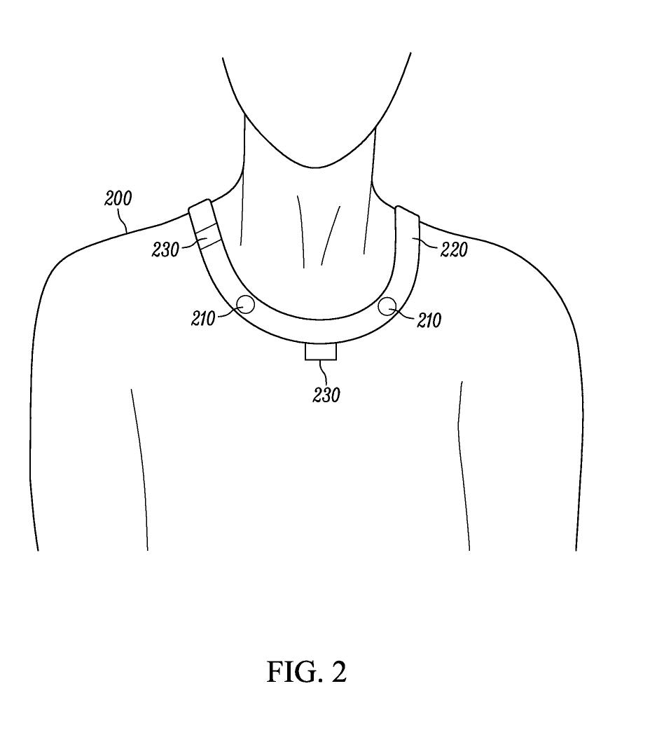

FIG. 2 is an exemplary diagram of a body 200 with sensor units 210 attached thereto. It should be noted that body 200 could be the user of the personal massaging device 100, or could be another party who is not in physical contact with personal massaging device 100. In this exemplary embodiment, sensor units 210 are electrocardiogram (EKG or ECG) electrodes placed in the region of the heart of body 200. Sensor units 210 could similarly be capacitive sensors or any other conventional sensor used to obtain EKG signals. The voltage signal generated by the heart can be easily measured, typically on the millivolt level, using appropriately positioned sensor units 210. Frequently, dual sensors can be used, which process the signal differentially, thus dramatically reducing noise and pickup from EMI or capacitively coupled sources, such as power lines.

In this example, the sensor units 210 are incorporated as part of a necklace 220, which functions to keep the sensor units 210 in the correct position to read the signals, but can also provide an aesthetically pleasing mechanism for sensing biofeedback signals.

Necklace 220 can further include a transmitter 230 capable of wirelessly communicating with personal massaging device 100, via cellular communication, WiFi, Bluetooth, or any other wireless communication technique. Transmitter 230 could be located anywhere on the necklace 220, or could be incorporated as a pendant, or the like. The biofeedback signals sensed by sensor units 210 can be transmitted via transmitter 230 in real time. Transmitter 230 can either transmit raw data information, such as a voltage trace of the biopotential signal (such as EEG or EKG), or a processed form of the data (such as whether alpha or gamma waves are dominant in the case of EEG, showing various mental states, or the heartrate in the case of EKG). In this case, a processor unit may be housed communicatively coupled to the sensor units 210 and transmitter 230, and may be configured to process the data as necessary. In addition, transmitter 230 could send information that is semi-processed, such as filtered EKG or EEG information. As discussed in further detail below, necklace 220 could be worn by the user of the personal massaging device 100, or a partner.

Since the processor on the vibration unit can be reprogrammed, any number of possible input/output relationships are possible. For instance, the massager could pulse in time to the heartbeat, or harmonicas or subharmonics or the heartrate. Or, for instance, the intensity could vary based on heartrate, for instance slowing down if an elevated heartrate indicates too much vibration.

Similarly, the frequency content of EEG signals can be analyzed to indicate if alpha (typically indicating relaxation), beta (indicating alertness), theta (indicating meditation/light sleep), or gamma waves, etc, are dominant, indicating the mental state of the user. These can be used to map directly to outputs, such as more intense vibrations during alertness or meditation.

The biosensor output can be used to direct the output of the vibration, for example, in an algorithmic sense. For instance, the vibrations could vary through a large number of different patterns intensities, using biofeedback to get a sense of how the user is responding (for instance, higher pulse rate could indicate enjoyment). This type of interaction could be used to generate a “map” of, what is or is not enjoyable for the user, and the vibration patterns could be changed, via an algorithm, to center on patterns that are most enjoyable to the user.

Upon reception at the personal massaging device 100, the signal(s) transmitted by transmitter 230 corresponding to a sensed biofeedback signal (e.g., a heartbeat, according to the present embodiment), the processor can analyze the received signal and assign a corresponding pre-programmed output stored in the memory unit of personal massaging device 100. According to one example, the pre-programmed output may be to pulse the vibrator motor(s) within massaging device 100 at a rhythm consistent with the sensed heartbeat. As an alternative, the intensity of the vibrator motor(s) that the user of personal massaging device 100 experiences can increase or decrease as the sensed beats per minute rises or falls. As mentioned above, vibration is not the only possible output; the personal massaging device 100 can also be pre-programmed to increase its temperature, illuminate a light source (e.g., LED lighting) or produce audible sound consistent with the real-time biofeedback signals sensed by sensor units 210. One of ordinary skill in the art would realize that this can be further expanded to include the use of lights or dual vibrator motors, which can be phased to respond to different aspects of the EKG trace. For instance, each heartbeat could result in a “back to front” activation pattern of the motors. However, this is by no means a complete description of the ways in which the input/output relationship can be formed; various other interactions can be output, such as incorporating the heart rate signal with pressure, accelerometer detections, button press data entered by a user, and/or the amount of time the program has been running (for instance, taking several minutes to “warm up”).

The reprogrammable outputs can be stored in the memory of personal massaging device 100 during production, or a user can select which outputs to assign to which sensed biofeedback signals. Thus, the output stimuli can be modifiable and/or reprogrammable by a user. The user could select different types of input/output relationships (such as pre-programmed “games” or “apps) using buttons on the handle 120, or other inputs to the system, such as the accelerometer 140. For example, “apps” could be selected, based on how the device is pointing when started up, or when the button is pressed. There could also be fixed apps, so only one starts up; an app to go only through the network connection. One of ordinary skill in the art would understand that the apps can be changed/loaded via any wireless network, or other communication mechanism.

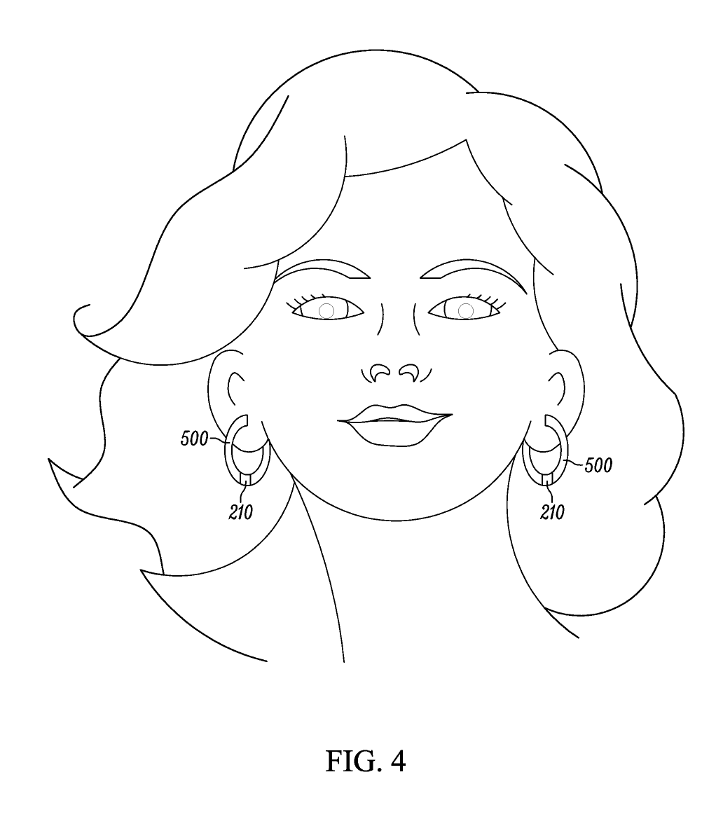

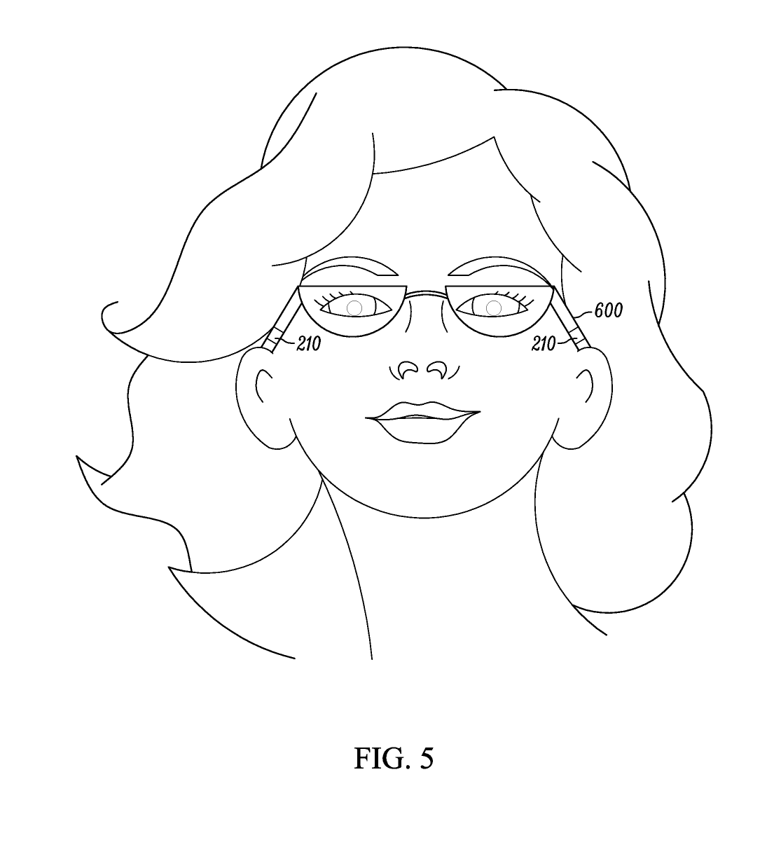

In the exemplary embodiment depicted in FIG. 2, the sensor units 210 are incorporated as part of necklace 220; however, other similar wearable items can be employed to communicatively connect sensor units 210 to a body. For example, sensor units 210 could be incorporated into a ring 300 (FIG. 3), earrings 500 (FIG. 4), spectacles 600 (FIG. 5), etc., positioned on body 200 in order to sense a biofeedback signal, such as a heartbeat, or other forms which bring sensor units 210 into contact with the body, such as sensors embedded in clothing, for example. In the depicted embodiments, various numbers of sensor units 210 are placed at various locations. It should be understood that any number of sensor units 210 may be placed at different locations on the respected apparatus in order to sense biopotential signals, without departing from the scope of the present disclosure.

In the examples above where sensor units 210 are incorporated with an aesthetic design (e.g., as part of necklace 220 or ring 300). The electronic components for the biosensor unit 210, microcontroller, and transmitter could be built into the apparatus using the bare IC die, rather than the typically epoxy overmolded chips. Using the bare die decreases size and weight, and also gives an attractive, jewelry like look to the device, because the iridescent die could be covered with a clear enclosure or potting material.

It should be further noted that sensing only the heartbeat is by no means necessary—the output could be dependent on harmonics or sub-harmonics of the heart rate, thus increasing the dynamic range of the output. Similarly, measurements such as overall activity, or any change in activity (e.g., quickly speeding up or slowing down) can be used to determine a corresponding output.

Although EKG signals are described above, one of ordinary skill in the art would realize that electromyography (EMG) or electroencephalography (EEG) signals could be detected using conventional sensor units 210. In the case of detecting EMG signals, electrical potentials from muscles are measured directly. In the case of detecting EEG signals, electrical activity from the brain can result in a measurable potential on the surface of the skin, which can be measured non-invasively. Similarly to the EKG case described above, the output can either be locked to brain waves, or probably more typically, subharmonics of the brain waves, since they are relatively high frequency. A transition between different states of alertness and arousal, typically exhibited by a shift in underlying frequency of the EEG activity could be used to determine an appropriate output. Moreover, other methods of processing could be used, such as detection of dreaming, etc. Again, differential measurement, while not strictly required, can be utilized to greatly reduce interference.

Similarly, an event-related potential (ERP) response to a vibratory stimulus can be measured and classified using techniques that have been established in the field. The resultant ERP/stimuli information can be used to direct and influence the input/output relationship of the device. For instance, certain characteristic ERPs may indicate changes in user attention and/or alertness correlated in time with a stimulus, and could correspondingly be used to modify the presentation of that or additional stimuli. Or, for instance, certain characteristic ERPs may indicate user displeasure or interest with in stimulus, and could correspondingly be used to decrease or increase the frequency of presentation of those stimuli.

Other types of sensor units 210 can include microphone(s) configured to receive sound vibrations, which can be processed and analyzed to determine various outputs from the massaging device 100. A “voice coil” type of vibration device can be employed, which is constructed similarly to an audio speaker with a weight attached to cause shaking in the massaging device 100, as one exemplary output.

Appropriate sensor units 210 can be utilized to obtain galvanic, skin response, blood oxygen levels, temperature, and/or respiration. Each biofeedback signal can be similarly used as a basis for an output by massaging device 100. Various combinations of biofeedback signals can be a basis for various algorithmic outputs in order to produce stimuli for a unique and modifiable user experience.

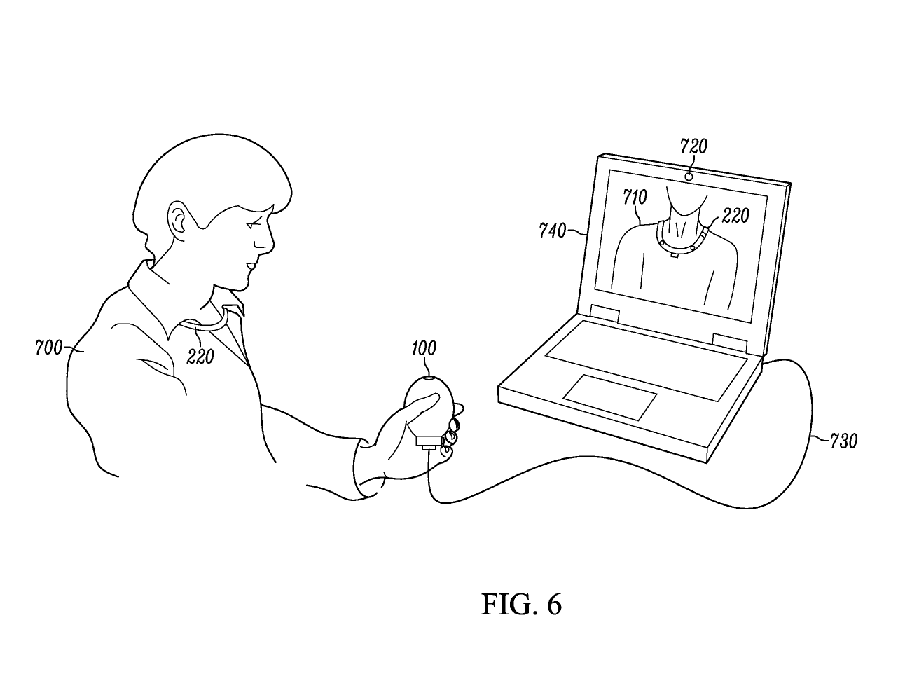

As noted above, the biofeedback signal can originate from either the person using the personal massaging device 100 (for instance, allowing the device to speed up increase intensity with alertness or arousal of the user), or can be detected from another person, for an intimate interpersonal experience. In the case where the device is being connected to the biopotentials of the user of the personal massaging device 100, the connection can be wired, or wireless. In the case where the biofeedback is from a partner, the connection can be wired, wireless, or through a network connection (i.e., the partner can be located a distance away). As shown in FIG. 6, a user 700 of the personal massaging device 100 can interact with a partner 710 via a webcam and microphone 720, for example, at any distance, via the Internet. In this case, the partner 710 and/or the user 700 are in physical contact with sensor units 210 (included on a necklace 220, according to this example), and can maintain a visual with the user 700 of the personal massaging device 100. Biofeedback signals from the partner sensed by sensor units 210 can be transmitted via a network connection or cellular connectivity, for example, directly to personal massaging device 100 or another processor communicatively coupled to personal massaging device 100 (e.g., the user's computer 740 communicatively coupled to personal massaging device 100 via wireless connection or hard wired 730 connected to a USB port, for example). The sensed signals by sensor units 210 can be transmitted to the network via a wired or wireless connection. Processor unit 180 of the personal massaging unit 100 can interpret the signal(s) in real time and assign a corresponding output from memory unit 170, dependent on the biofeedback of the partner remotely located. The exemplary embodiment of FIG. 6 depicts partner 710 at a remote location observing user 700 via a webcam, but one of ordinary skill in the art would understand that both the user 700 and partner 710 could be in close proximity, such as in the same room. It also to be understood that the communication device could be a personal computer, a cellular telephone, tablet computing device, or any other device which allows for a connection to a wireless or wired sensor and network.

Although certain embodiments above describe sensor units 210 located on various objects (e.g., necklace 220), it should be understood that sensor units 210 could be placed at either end of personal massager 100 itself, in order to sense biopotential signals from the user of the massager 100, in real time as the user is experiencing stimuli from the massager 100 (see FIG. 1). In this example, the biopotential can be sensed between the hand of the user holding handle 120 and a body part in contact with another part of the massager 100.

As a result of the foregoing methods and systems a user of a massaging device 100 can experience varying stimulation dependent upon biofeedback signals obtained by sensors units 210 communicatively coupled to the user or even a partner. The biofeedback signals can be used to determine one or more predefined outputs stored in a memory, such that the massaging device 100 can automatically produce any corresponding output varying with the sensed biofeedback signals in real time.

While various embodiments of the invention have been described above, it should be understood that they have been presented by way of example only, and not by way of limitation. Likewise, the various diagrams may depict an example architectural or other configuration for the disclosure, which is done to aid in understanding the features and functionality that can be included in the disclosure. The disclosure is not restricted to the illustrated example architectures or configurations, but can be implemented using a variety of alternative architectures and configurations. Additionally, although the disclosure is described above in terms of various exemplary embodiments and implementations, it should be understood that the various features and functionality described in one or more of the individual embodiments are not limited in their applicability to the particular embodiment with which they are described. They instead can be applied alone or in some combination, to one or more of the other embodiments of the disclosure, whether or not such embodiments are described, and whether or not such features are presented as being a part of a described embodiment. Thus the breadth and scope of the present disclosure should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; and adjectives such as “conventional,” “traditional,” “normal,” “standard,” “known”, and terms of similar meaning, should not be construed as limiting the item described to a given time period, or to an item available as of a given time. But instead these terms should be read to encompass conventional, traditional, normal, or standard technologies that may be available, known now, or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the disclosure may be described or claimed in the singular, the plural is contemplated to be within the scope thereof unless limitation to the singular is explicitly stated. The presence of broadening words and phrases such as “one or more,” “at least,” “but not limited to”, or other like phrases in some instances shall not be read to mean that the narrower case is intended or required in instances where such broadening phrases may be absent.

Furthermore, although individually listed, a plurality of means, elements or method steps may be implemented by, for example, a single unit or processing logic element. Additionally, although individual features may be included in different claims, these may possibly be advantageously combined. The inclusion in different claims does not imply that a combination of features is not feasible and/or advantageous. Also, the inclusion of a feature in one category of claims does not imply a limitation to this category, but rather the feature may be equally applicable to other claim categories, as appropriate.

What is claimed is:

1. A multi-mode personal massaging system, comprising:
a sensor unit configured to detect one or more biofeedback signals from one or more bodies;
a controller configured to analyze the one or more biofeedback signals, and determine one or more corresponding outputs stored in a memory, based on the one or more biofeedback signals; and
a massaging unit configured to output the one or more outputs determined by the controller, based on the one or more biofeedback signals.

2. The multi-mode personal massaging system according to claim 1, wherein the one or more biofeedback signals include an electrocardiogram (EKG) signal.

3. The multi-mode personal massaging system according to claim 1, wherein the one or more biofeedback signals include an electromyography (EMG) signal.

4. The multi-mode personal massaging system according to claim 1, wherein the one or more biofeedback signals include an electroencephalography (EEG) signal.

5. The multi-mode personal massaging system according to claim 1, wherein the one or more biofeedback signals include motion of the massaging unit.

6. The multi-mode personal massaging system according to claim 1, wherein the one or more biofeedback signals include at least one signal related to at least one of galvanic skin response, blood oxygen levels, temperature, and respiration

7. The multi-mode personal massaging system according to claim 1, wherein the sensor unit is configured to detect the one or more biofeedback signals from a person receiving the output from the massaging unit.

8. The multi-mode personal massaging system according to claim 1, wherein the sensor unit is configured to detect the one or more biofeedback signals from a person other than a person receiving the output from the massaging unit.

9. The multi-mode personal massaging system according to claim 1, further comprising a transmitting unit configured to transmit the detected one or more biofeedback signals to the controller, using at least one of a hard-wired or wireless communication mechanism.

10. The multi-mode personal massaging system according to claim 9, wherein the detected one or more biofeedback signals are transmitted via the Internet.

11. The multi-mode personal massaging system according to claim 1, wherein the one or more outputs include one or more vibration pulses corresponding to a heartbeat detected by the sensor unit.

12. The multi-mode personal massaging system according to claim 1, wherein the one or more outputs are determined based on a rate of change in the one or more biopotential signals detected by the sensor unit.

13. The multi-mode personal massage system according to claim 1, wherein the one or more outputs is determined based on calculated stimuli/response pairing, using event-related potentials (ERPs).

14. The multi-mode personal massaging system according to claim 1, wherein the one or more outputs include at least one of vibration, illumination and heat.

15. The multi-mode personal massaging system according to claim 1, wherein at least one of the one or more sensor units is incorporated into at least one of the massaging unit, a necklace, a ring, an earring, spectacles, and clothing.

16. A method for personal massaging, comprising:
detecting one or more biofeedback signals from one or more bodies;
analyzing the one or more biofeedback signals, and determining one or more corresponding outputs, based on the one or more biofeedback signals; and
outputting the one or more determined outputs, based on the one or more biofeedback signals.

17. The method of claim 16, wherein the one or more biofeedback signals include an electrocardiogram (EKG) signal.

18. The method of claim 16, wherein the one or more biofeedback signals include an electromyography (EMG) signal.

19. The method of claim 16, wherein the one or more biofeedback signals include an electroencephalography (EEG) signal.

20. The method of claim 16, wherein the one or more biofeedback signals include motion of the massaging unit.

21. The method of claim 16, wherein the one or more biofeedback signals include at least one signal related to at least one of galvanic skin response, blood oxygen levels, temperature, and respiration.

22. The method of claim 16, wherein the one or more biofeedback signals are detected from a person directly receiving the output.

23. The method of claim 16, wherein the one or more biofeedback signals are detected from a person other than a person directly receiving the output.

24. The method of claim 16, further comprising transmitting the detected one or more biofeedback signals to a processor configured to perform the analyzing, using at least one of a hard-wired or wireless communication mechanism.

25. The method of claim 24, wherein the detected one or more biofeedback signals are transmitted via the Internet.

26. The method of claim 16, wherein the one or more outputs include one or more vibration pulses corresponding to a heartbeat detected by the detecting.

27. The method of claim 16, wherein the one or more outputs are determined based on a rate of change in the one or more biofeedback signals detected by the detecting.

28. The method of claim 16, wherein the one or more outputs is determined based on calculated stimuli/response pairing, using event-related potentials (ERPs).

29. The method of claim 16, wherein the one or more outputs include at least one of vibration, illumination and heat.

30. The method of claim 16, wherein the detecting is performed by at least one sensor unit incorporated into at least one of the massaging unit, a necklace, a ring, an earring, spectacles, and clothing.
